(19) United States
(12) Patent Application Publication
(10) Pub. No.: US 2007/0231664 A1
(43) Pub. Date: Oct. 4, 2007

(54) Fuel cell stack

(75) Inventors: Hans-Rainer Zerfass, Taunusstein (DE); Armin Diez, Lenningen (DE); Peter Schenk, Hohenstein (DE); Wolfgang Fritz, Metzingen (DE)

Correspondence Address: Mr. Edward J. Timmer, P.O. Box 770, Richland, MI, 49083-0770, US

(73) Assignee: ElringKlinger AG

(21) Appl. No.: 11/728,440

(22) Filed: Mar. 26, 2007

(30) Foreign Application Priority Data
Mar. 30, 2006 (DE) 10 2006 016 001.0

(51) Int. Cl. H01M 2/08; H01M 8/24

(52) U.S. Cl. 429/36; 429/38

(57) ABSTRACT

In order to produce a fuell cell stack which comprises a plurality of fuel cell units succeeding one another in the direction of the pile and wherein each of the fuel cell units comprises a housing incorporating at least one housing part consisting of a metallic material, such that the fuel cell units thereof are of simple construction and also exhibit an adequate electrically insulating effect and adequate mechanical rigidity even at a high operating temperature of the fuel pile, it is proposed that the fuell cell stack should comprise at least one distributor element which comprises at least one gas distribution channel for supplying a fuel gas or an oxidizing agent to a plurality of fuel cell units or for removing an exhaust gas or surplus oxidizing agent from a plurality of fuel cell units, wherein at least one housing part of at least one fuel cell unit is brazed to the at least one distributor element.

### RELATED APPLICATION

The present disclosure relates to the subject matter disclosed in German Patent Application No. 10 2006 016 001.0 of Mar. 30, 2006, the entire specification of which is incorporated herein by reference.

### FIELD OF DISCLOSURE

The present invention relates to a fuell cell stack which comprises a plurality of fuel cell units succeeding one another in the direction of the pile, wherein each of the fuel cell units comprises a housing incorporating at least one housing part which consists of a metallic material.

For the purposes of setting the desired operating voltage, the necessary number of fuel cell units are arranged one upon the other in order to obtain a fuell cell stack (fuel cell pile). In order to prevent an electrical short-circuit, the housings of the successive fuel cell units in the fuell cell stack must be electrically insulated from one another. Moreover, it is necessary to separate the fuel gas channels of the fuell cell stack from the oxidizing agent chambers of the fuel cell units in gas-tight manner and to separate the oxidizing agent channels of the fuell cell stack from the fuel gas chambers of the fuel cell units in gas-tight manner.

### BACKGROUND

In the case of known fuell cell stacks, sealing and insulating elements are arranged between the fuel cell units succeeding one another in the direction of the pile in order to obtain the requisite electrically insulating effect and the requisite sealing effect.

### SUMMARY OF THE INVENTION

The object of the present invention is to provide a fuell cell stack of the type mentioned hereinabove wherein the fuel cell units thereof are of simple construction and wherein the pile also exhibits an adequate electrically insulating effect and adequate mechanical rigidity even at a high operating temperature of the fuel pile.

In accordance with the invention, this object is achieved in the case of a fuell cell stack incorporating the features indicated in the preamble of Claim 1 in that the fuell cell stack comprises at least one distributor element which comprises at least one gas distribution channel for supplying a fuel gas or an oxidizing agent to a plurality of fuel cell units or for removing exhaust gas or surplus oxidizing agent from a plurality of fuel cell units, wherein at least one housing part of at least one fuel cell unit is brazed to the at least one distributor element.

Thus, the concept underlying the solution in accordance with the invention is that the gas distribution channels for supplying the fuel gas or the oxidizing agent to the fuel cell units and the gas distribution channels for removing exhaust gas or surplus oxidizing agent from the fuel cell units should not be formed by a succession of mutually aligned gas passage openings in the housings of the fuel cell units but rather that the gas distribution channels be provided instead in at least one distributor element (a manifold) that is formed separately from the housings of the fuel cell units, and that the respective housings of each of the fuel cell units be individually fixed to the at least one distributor element.

In the solution in accordance with the invention, the housings of the fuel cell units succeeding one another in the direction of the pile preferably do not fit directly together, so that one can dispense with the arrangement of sealing and insulating elements between the housings of the fuel cell units succeeding one another in the direction of the pile.

The requisite electrically insulating effect and the requisite sealing effect are both obtained in the fuell cell stack in accordance with the invention by the connection of the housing parts of the fuel cell units to the at least one distributor element.

Thus, provision may be made, in particular, for the at least one housing part and the at least one distributor element to be brazed to one another by means of a braze material which is electrically insulating at the operating temperature of the fuell cell stack.

Such a braze material can, in particular, be in the form of a glass solder material.

In the case of some of the usually used brazing and/or sealing materials, the electrical resistance at the operating temperature of a high temperature fuel cell unit (in the range of approximately 800° C. to approximately 900° C.) is no longer high enough for achieving a satisfactory insulating effect. Furthermore, the stability of some of the brazing and/or sealing materials that are usually used is very low vis a vis the changes in temperature (between the operating and quiescent phases) that frequently occur in a high temperature fuel cell unit.

A particularly good electrically insulating effect and adequate mechanical rigidity is advantageously obtained even at a high operating temperature of the fuell cell stack, if the at least one housing part is provided with a coating of a ceramic material and is brazed to the at least one distributor element at at least one position that is provided with the ceramic coating.

As an alternative or in addition thereto, provision may also be made for the at least one distributor element to be provided with a coating of a ceramic material and be brazed to the at least one housing part at at least one position that is provided with the ceramic coating.

A load bearing connection between the at least one housing part and the at least one distributor element that is particularly strong mechanically is obtained, if the at least one housing part and the at least one distributor element are brazed to one another by means of a metallic braze.

The metallic braze is solid at the operating temperature of the fuell cell stack.

The ceramic coating is formed from a ceramic material which exhibits an electrically insulating effect at the operating temperature of the fuell cell stack so that the electrical insulation between the housings of the fuel cell units on the one hand and the at least one distributor element on the other is ensured by means of this ceramic coating.

Since the electrical insulation has already been achieved by virtue of the ceramic coating, a metallic braze that is very thermally stable and highly adaptable to changes in temperature can be used instead of a glass solder or a ceramic sealing material for the mechanical connection of the housings of the fuel cell units to the at least one distributor element.

Moreover, the concept in accordance with the invention permits a durable connection between the housings of the fuel cell units succeeding one another in the direction of the pile on the one hand and the at least one distributor element on the other to be created in a simple manner so that the construction of the fuell cell stack can be effected in a particularly simple and rapid manner by successively bonding the housings of the fuel cell units to the at least one distributor element.

In principle, the ceramic coating can be formed from any ceramic material which has a sufficiently high specific electrical resistance at the operating temperature of the fuell cell stack.

Ceramic coatings such as those comprising aluminium oxide and/or titanium dioxide and/or zirconium dioxide and/or magnesium oxide are particularly suitable.

The ceramic coating can be produced by a thermal spraying process, in particular by an atmospheric plasma spraying process, by a vacuum plasma spraying process or by a flame spraying process for example.

In a special embodiment of the seal arrangement in accordance with the invention, provision is made for the at least one housing part and/or the at least one distributor element to be formed from a metallic alloy which contains an oxidisable constituent.

In particular, provision may be made for the metallic alloy to contain aluminium and/or zirconium as the oxidisable constituent.

Given the presence of an oxidisable constituent in the metallic alloy from which the housing part is formed, the ceramic coating can be produced by oxidation of the oxidisable constituent, aluminium and/or zirconium for example, in the metallic alloy.

Preferably, the thickness of the ceramic coating is approximately 20 μm to approximately 1,000 μm.

For the purposes of brazing the ceramic coating on the at least one housing part to the at least one distributor element, use can be made, in particular, of a silver based braze.

Such a silver based braze can be used with or without an additive of elemental copper.

If the silver based braze without an additive of elemental copper is used, then it is expedient if the silver based braze contains an additive of copper oxide since the silver based braze is then better able to wet ceramic surfaces due to the additive of copper oxide.

Furthermore, the silver based braze may comprise a titanium additive for improving the wetting process.

The braze used for brazing the at least one housing part to the at least one distributor element is made up of an intimate mixture of components from which the braze alloy will only form in situ when they are heated up to the brazing temperature.

Furthermore, an active braze can also be used for brazing the at least one housing part to the at least one distributor element.

Active brazes are metallic alloys which contain small quantities of boundary-surface-active elements (e.g. titanium, zirconium, hafnium, niobium and/or tantalum) and are thus able to lower the boundary surface energy between a ceramic material and the braze melt to such an extent that wetting of the ceramic material by the braze can take place.

This active brazing technique using active brazes enables ceramic-ceramic/metal bonds to be produced in the course of a single-step bonding process without a preceding step of metallizing the ceramic bonding surfaces. The wetting of the ceramic bonding surfaces by the braze is thus ensured by virtue of using the active braze.

A suitable active braze is sold under the name “Copper ABA” by the company Wesgo Metals, 610 Quarry Road, San Carlos, Calif. 94070, USA for example.

This active braze has the following composition: 2 percentage weight Al; 92.7 percentage weight Cu; 3 percentage weight Si; and 2.3 percentage weight Ti.

In a preferred embodiment of the fuell cell stack in accordance with the invention, provision is made for the housing of at least one fuel cell unit to comprise at least two housing parts made of a metallic material which are both brazed to the at least one distributor element.

In order to produce a gas-tight housing for the fuel cell unit, provision may be made for the at least two housing parts of the housing of the at least one fuel cell unit to be fixed together, preferably by welding and/or brazing.

Hereby, at least one of the housing parts can comprise at least one passage opening through which, in the assembled state of the fuell cell stack, a cathode electrolyte anode unit of the fuel cell unit is accessible for enabling electrical contact to be made by another fuel cell unit of the fuell cell stack.

As an alternative or in addition thereto, provision may be made for at least one of the housing parts to comprise a contact field for making electrical contact with a cathode electrolyte anode unit of another fuel cell unit of the fuell cell stack.

Furthermore, provision may be made for a cathode electrolyte anode unit of the fuel cell unit to be fixed either directly or via a substrate of the cathode electrolyte anode unit to at least one of the housing parts, for example, by brazing and/or by welding.

In a particularly preferred embodiment of the invention, provision is made for two housing parts of the fuel cell unit, in particular, an upper housing part and a lower housing part, to form together a complete, two-piece housing for the fuel cell unit without the need for further, and in particular, metallic housing parts being required for this purpose.

This housing can enclose, in particular, a cathode electrolyte anode unit of the fuel cell unit between the two housing parts.

The at least one housing part of the fuel cell unit is preferably formed from a metal sheet.

In particular, the housing part can be in the form of a sheet metal preform which is formed by a shaping and/or stamping process from a substantially flat sheet of metal.

Provision is preferably made for the at least one housing part to be in the form of a highly corrosion resistant steel. Adequate corrosion resistance of the housing part is thereby obtained even at the high operating temperature of a SOFC (Solid Oxide Fuel Cell) fuel cell unit.

It is particularly expedient, if the corrosion resistant steel which is commercially available under the trade name “Aluchrom Y” or “FeCrAlY” is used as the material for the housing part.

In order to obtain a particularly simple construction for the fuell cell stack, provision may be made for the at least one housing part not to comprise a passage opening for a fuel gas, an oxidizing agent or an exhaust gas. In this case, the supply and removal of gases to the fuel cell units is effected exclusively by the at least one distributor element or by a plurality of distributor elements.

In order to supply the fuel cell unit with a fuel gas or an oxidizing agent or to remove an exhaust gas or an oxidizing agent from the fuel cell unit, provision may be made for the housing of at least one fuel cell unit to comprise at least one passage opening for a fuel gas, an oxidizing agent or an exhaust gas which is connected to a gas distribution channel in the at least one distributor element.

In particular, provision may be made for the at least one distributor element to comprise at least one gas branch channel which branches off from the at least one gas distribution channel and via which the at least one passage opening of the housing of the at least one fuel cell unit is connected to the at least one gas distribution channel.

Such a passage opening can be formed, in particular, in that it is bounded laterally by at least one region of the housing of the fuel cell unit which comprises a folded edge.

Furthermore, in a preferred embodiment of the invention, provision is made for the at least one distributor element to comprise at least one seating for the at least one housing part which accommodates a boundary region of the housing part.

Such a seating can, in particular, be in the form of a seating slot.

In order to obtain a particularly stable fuell cell stack which comprises all of the necessary gas distribution channels, it is expedient for the fuell cell stack to comprise at least two distributor elements which each incorporate at least one gas distribution channel, and wherein the at least one housing part of at least one fuel cell unit is brazed on two mutually opposite sides thereof to a respective one of the distributor elements.

Further features and advantages of the invention form the subject matter of the following description and the graphic illustration of exemplary embodiments.

### BRIEF DESCRIPTION OF THE DRAWINGS

FIG. 1 shows a schematic perspective illustration of a fuell cell stack which comprises a plurality of fuel cell units that succeed one another in the direction of the pile and are held between two distributor elements which comprise gas distribution channels for supplying a fuel gas and an oxidizing agent to the fuel cell units and for removing exhaust gas and surplus oxidizing agent from the fuel cell units;

FIG. 2 a schematic perspective illustration which shows a section of the fuell cell stack and in particular the outlets of the gas branch channels from that side of one of the distributor elements which faces the fuel cell units;

FIG. 3 a schematic perspective illustration corresponding to FIG. 2 of a section of the fuell cell stack, wherein one of the distributor elements has been removed in order to show the lateral edges of the housings of the fuel cell units;

FIG. 4 a schematic vertical section through the fuell cell stack in the vicinity of a fuel gas supply channel;

FIG. 5 a schematic vertical section through the fuell cell stack in the vicinity of an oxidizing agent supply channel;

FIG. 6 a schematic vertical section through the fuell cell stack in the vicinity of an edge of the housing of the fuel cell units running transversely to the distributor elements; and

FIG. 7 a schematic vertical section corresponding to FIG. 6 through a second embodiment of a fuell cell stack wherein an electrically insulating layer is not arranged on the housings of the fuel cell units, but on an external housing of the fuell cell stack.

Similar or functionally equivalent elements are designated by the same reference symbols in all of the Figures.

### DETAILED DESCRIPTION OF THE INVENTION

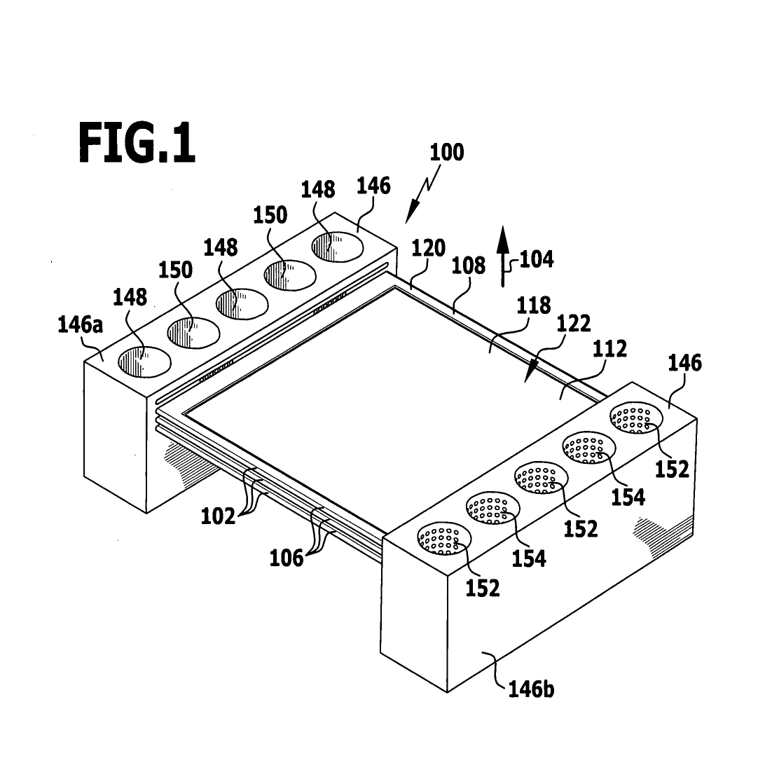

A fuell cell stack which is illustrated in FIGS. 1 to 6 and bears the general reference 100 therein comprises a plurality of fuel cell units 102 of respectively like construction which are stacked one on top of the other in the vertical direction 104 of the pile.

Three such fuel cell units 102 are illustrated exemplarily in the drawings; in practice however, the number thereof will usually be significantly greater.

Each of the fuel cell units 102 comprises a housing 106 which is composed of an upper housing part 108 and a lower housing part 110 as well as an electro-chemical unit 112 which is held between the upper housing part 108 and the lower housing part 110 and which, for its part, comprises a substrate 114, a contact material 116 that is arranged on the side of the substrate 114 facing the lower housing part 110 and a cathode electrolyte anode unit (KEA unit) 118 that is arranged on the surface of the substrate 114 remote from the contact material 116.

The upper housing part 108 is in the form of a sheet-metal preform and comprises a substantially rectangular and substantially flat metal sheet 120 that is provided with a substantially rectangular central passage opening 122 through which, in the fully assembled state of the fuel cell unit 102, the KEA unit 118 of the fuel cell unit 102 is accessible for contacting-making purposes by the lower housing part 110 of the fuel cell unit 102 located thereabove in the direction of the pile 104.

The metal sheet 120 is provided along its outer edges with a peripheral folded edge 124 which is formed by bending out an outermost boundary region of the metal sheet 120 from the plane of the metal sheet 120 along a bending line 126 and then folding it back against the lower surface 128 of the metal sheet 120.

The folded edge 124 that has been formed in this manner is interrupted periodically along two mutually opposite sides of the upper housing part 108 because the otherwise folded boundary region of the metal sheet 120 has been removed by being punched out or cut out at these points. This periodic removal of the folded edge 124 serves to form respective fuel gas inlet openings 130 and respective exhaust gas outlet openings that are located opposite the fuel gas inlet openings 130 in the housing 106 of the fuel cell unit 102.

The upper housing part 108 is preferably made of a highly corrosion resistant steel, for example, from the alloy Crofer 22.

The material Crofer 22 has the following composition: 22 percentage weight chromium; 0.6 percentage weight aluminium; 0.3 percentage weight silicon; 0.45 percentage weight manganese; 0.08 percentage weight titanium; 0.08 percentage weight lanthanum; the remainder iron.

This material is sold by the company ThyssenKrupp VDM GmbH, Plettenberger Straβe 2, 58791 Werdohl, Germany.

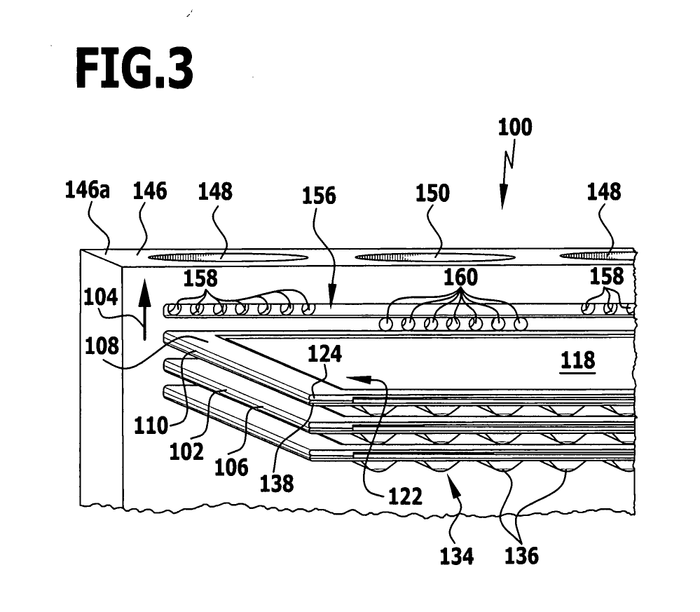

The lower housing part 110 is likewise in the form of a sheet-metal preform and comprises a substantially rectangular metal sheet 132 which is oriented perpendicularly to the direction of the pile 104 and comprises a substantially rectangular central contact field 134 which is provided with contact elements for making contact with the contact material 116 on the one hand and with the cathode of a KEA unit 118 of a neighbouring fuel cell unit 102 on the other, wherein these contact elements may be corrugated(as illustrated in FIG. 3) or dimpled.

The lower housing part 110 too is provided along the outer edges of the metal sheet 132 with a peripheral folded edge 138 which is formed by bending an outer boundary region of the metal sheet 132 along a bending line 140 and then folding this boundary region back onto the upper surface 140 of the metal sheet 132.

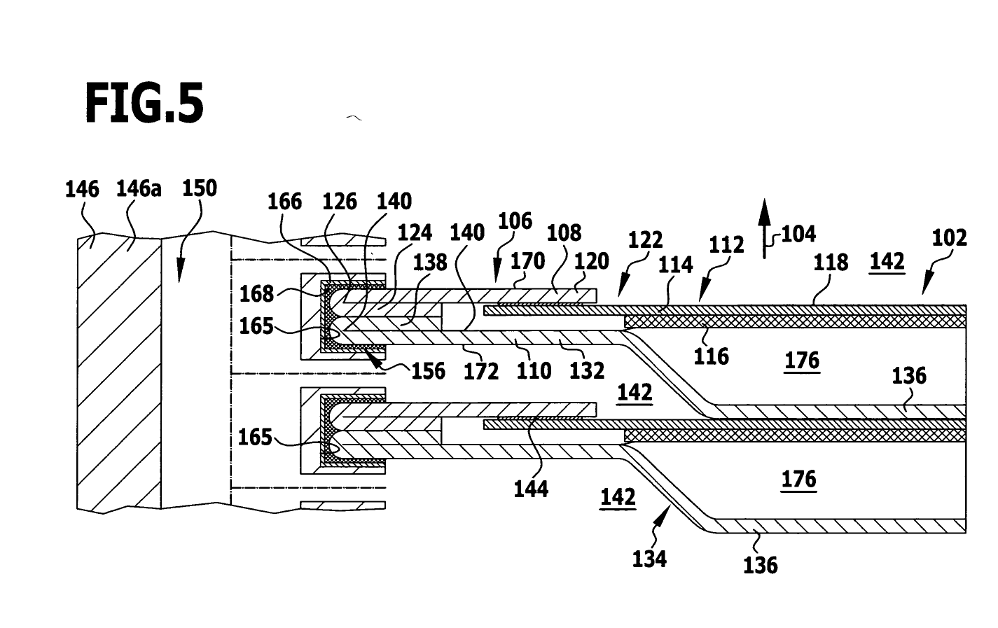

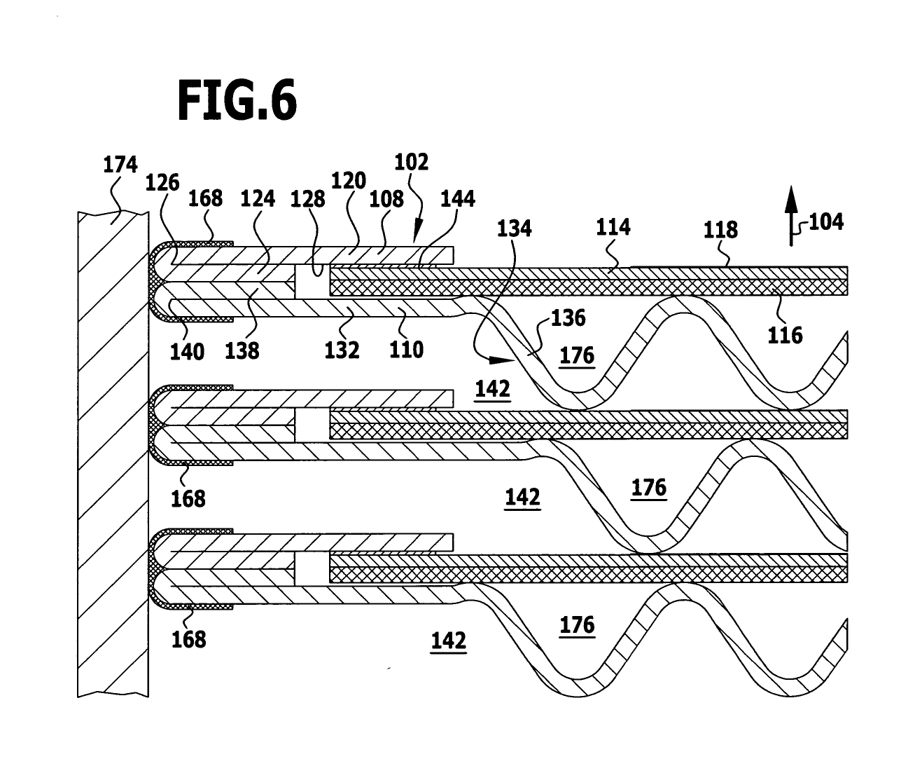

As can be seen from FIGS. 5 and 6, the folded edges 124 of the upper housing part 108 and 138 of the lower housing part 110 fit together in laminar manner. The folded edges 124 and 138 are fixed together in gas-tight manner by a welding and/or brazing process for example, so that the housing 106 of the fuel cell unit 102 is closed in gas-tight manner in the vicinity of the folded edges 124, 138.

The lower housing part 110 is also not provided with such a folded edge in those edge sections of the lower housing part 110 that correspond to the sections of the upper housing part 108 which are devoid of a folded edge, this being achieved in that the boundary region of the metal sheet 132 that would otherwise be used for the formation of the folded edge 138 has been removed by being punched out or cut out.

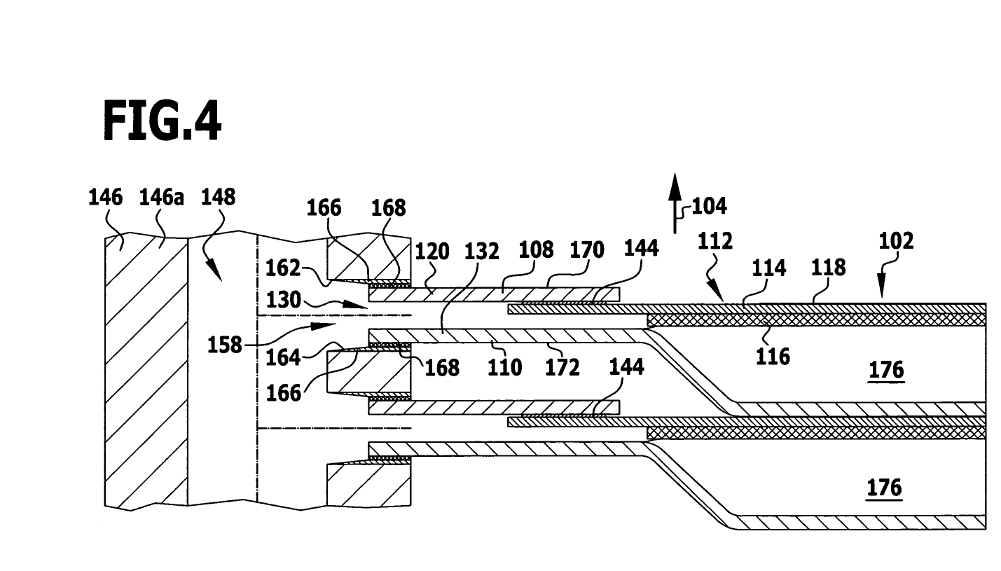

The already mentioned fuel gas inlet openings 130 and the exhaust gas outlet openings of the housing 106 of the fuel cell unit 102 that are located opposite thereto are produced as a result of the lack of the folded edges 124 and 138 in these sections (see in particular, FIG. 4).

The lower housing part 110 is preferably made of a highly corrosion resistant steel, for example, from the alloy Crofer 22 that has already been mentioned hereinabove.

The substrate 114 of the electro-chemical unit 112 can be in the form of a sintered body for example.

Such a sintered body can, for example, be formed from a FeCrAlY powder which is sold under the name FE-151 by the company Praxair in Indianapolis, Ill., USA. The approximate composition of this FeCrAlY powder is the following: 30 percentage weight Cr, 5 percentage weight Al, 0.5 percentage weight Y, the remainder of Fe.

The contact material 116 which is arranged between the substrate 114 and the lower housing part 110 can be in the form of a metal net, a metal weave or a metal fleece made, in particular, of nickel wire for example.

The KEA unit 118 which is arranged on the surface of the substrate 114 remote from the contact material 116 comprises an anode, an electrolyte arranged above the anode and a cathode arranged above the electrolyte.

The anode is formed from a ceramic material, from ZrO₂ or from a NiZrO₂-Cermet (ceramic metal mixture) for example, which is electrically conductive at the operating temperature of the fuel cell unit (from approximately 800° C. to approximately 900° C.), and it is porous in order to enable a fuel gas to pass through the anode to the electrolyte adjoining the anode.

A hydrocarbon-containing gas mixture or pure hydrogen can be used as the fuel gas for example.

The electrolyte is preferably in the form of a solid electrolyte, in particular, a solid oxide electrolyte, and it consists of yttrium-stabilized zirconium dioxide for example. The electrolyte is electronically non-conductive at normal temperatures and also at the operating temperature of the fuell cell stack 100. By contrast however, the ionic conductivity thereof rises with increasing temperature.

The cathode 111 is formed from a ceramic material which is electrically conductive at the operating temperature of the fuell cell stack 100, for example, from (La_{0.8}Sr_{0.2})_{0.98}MnO₃, and it is porous in order to enable an oxidizing agent, air or pure oxygen for example, to pass to the electrolyte from an oxidizing agent chamber 142 adjoining the cathode.

The gas-tight electrolyte of the KEA unit 118 extends up to the edge of the gas-permeable anode, whereby the surface area of the cathode is smaller than the surface area of the anode so that the electrolyte can be brazed at the boundary region thereof to the lower surface 128 of the upper housing part 108 by means of a braze layer 144.

The brazing material needed for the production of the braze layer 144 can be inserted in the form of a suitably cut brazing foil between the electrolyte and the upper housing part 108 or else it could be applied in the form of a bead of brazing material to the upper surface of the electrolyte and/or to the lower surface of the upper housing part 108 by means of a dispenser. Furthermore, it is also possible for the brazing material to be applied to the upper surface of the electrolyte and/or to the lower surface 128 of the upper housing part 108 by means of a pattern printing process, a silk-screen printing process for example.

A silver based braze with a copper additive can be used as the brazing material, for example, a silver based braze with the composition (in mol %): Ag4-Cu or Ag-8Cu. The brazing process takes place in an air atmosphere. The brazing temperature amounts to 1,050° C. for example, the duration of the brazing process to approximately 5 minutes for example. Copper oxide forms in situ during the process of brazing in air.

As an alternative thereto, a silver based braze without a copper additive could also be used as the brazing material. Such a copper-free braze offers the advantage of a higher solidus temperature (this amounts to approximately 960° C. without a copper additive, to approximately 780° C. with a copper additive). Since pure silver does not wet ceramic surfaces, Copper(II)oxide is added to the silver based brazes without a copper additive for the purposes of reducing the edge angle. The brazing process using silver based brazes without a copper additive takes place in an air atmosphere or in an inert gas atmosphere, for example, under argon.

In this case too, the brazing temperature preferably amounts to approximately 1,050° C., the duration of the brazing process to approximately 5 minutes for example.

As an alternative to brazing the electro-chemical unit 112 into the upper housing part 108, provision could also be made for a substrate 114, upon which the KEA unit 118 has not yet been produced, to be welded to the upper housing part 108 and after the welding process, the electro-chemically active layers of the KEA unit 118, i.e. the anode, electrolyte and cathode thereof, are produced successively on the substrate 114 that has already been welded to the upper housing part 108 using the vacuum plasma spraying process.

The previously described fuel cell units 102 are held between two manifolds or distributor elements 146, whereby the first distributor element 146a comprises a plurality of, three for example, fuel gas supply channels 148 which run in parallel with the direction of the pile 104 and also a plurality of, two for example, oxidizing agent supply channels 150 which are arranged to alternate with the fuel gas supply channels 148 and likewise run in parallel with the direction of the pile 104, whilst the second distributor element 146b located opposite to the first distributor element 146a comprises a plurality of, three for example, exhaust gas removal channels 152 which run in parallel with the direction of the pile 104 and a plurality of, two for example, oxidizing agent removal channels 154 which are arranged to alternate with the exhaust gas removal channels 152 and likewise run in parallel with the direction of the pile 104.

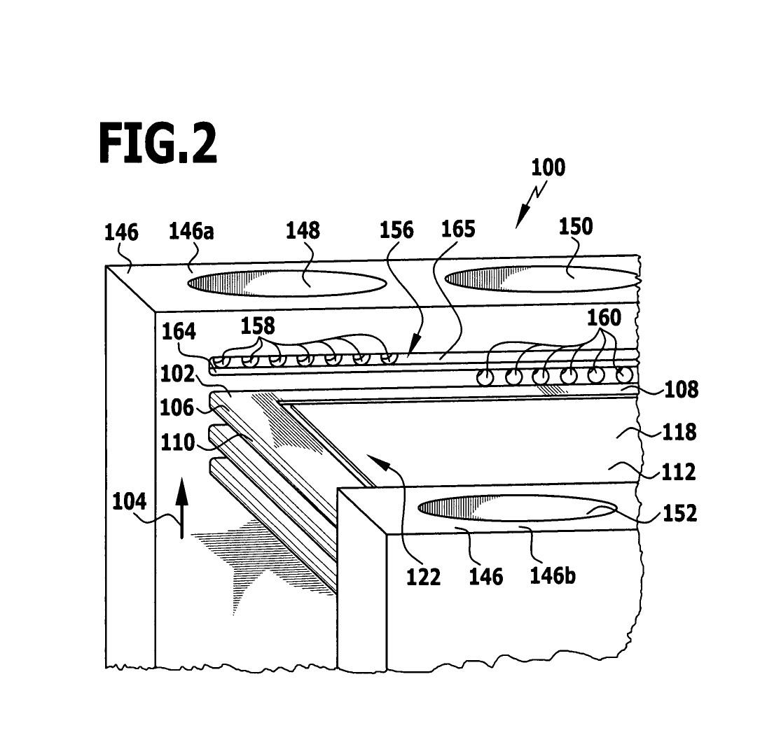

As can best be seen from FIGS. 2 and 3, each distributor element 146 comprises on the side thereof facing the fuel cell units 102 a row of seating slots 156 running perpendicularly to the direction of the pile 104, whereby each of the seating slots 156 serves to accommodate a boundary region of the housing 106 of a fuel cell unit 102 which contains the fuel gas inlet openings 130 or the exhaust gas outlet openings of the housing 106.

The seating slots 156 of the first distributor element 146a are connected to the fuel gas supply channels 148 of the first distributor element 146a by means of fuel gas branch channels 158 which run perpendicularly to the seating slots 156 and perpendicularly to the direction of the pile 104, whereby the fuel gas branch channels 158 each open out into the seating slots 156 in such a way that they are opposite a fuel gas inlet opening 130 of the housing 106 of a fuel cell unit 102.

In the region between the seating slots 156, the first distributor element 146a is provided with several oxidizing agent branch channels 160 which connect the oxidizing agent chambers 142 of the fuell cell stack 100 that are formed between the fuel cell units 102 succeeding one another in the direction of the pile 104 to the oxidizing agent supply channels 150 of the first distributor element 146a and which emerge from the outer surface of the first distributor element 146a facing the fuel cell units 102 in the regions between the seating slots 156.

As can be seen from FIGS. 1 to 3, the fuel gas branch channels 158 and the oxidizing agent branch channels 160 are preferably formed into groups each consisting of a plurality of, seven for example, channels, whereby these groups of channels are arranged to alternate in the longitudinal direction of the first distributor element 146a in correspondence with the alternating arrangement of the fuel gas supply channels 148 and the oxidizing agent supply channels 150.

In a corresponding manner, the second distributor element 146b is provided with seating slots 156 into which there merge exhaust gas branch channels that are located opposite the exhaust gas outlet openings of the housings 106 of the fuel cell units 102 and connect the latter to the exhaust gas removal channels 152 of the second distributor element 146b.

Oxidizing agent branch channels 160 which connect the oxidizing agent chambers 142 of the fuell cell stack 100 to the oxidizing agent removal channels 154 of the second distributor element 146b are arranged between the seating slots 156 of the second distributor element 146b.

In order to fix the housings 106 of the fuel cell units 102 to the distributor elements 146, the upper housing parts 108 are brazed to the upper boundary walls 162 of the seating slots 156, and the lower housing parts 110 are brazed to the lower boundary walls 164 of the seating slots 156 (see FIG. 4).

Moreover, the upper housing parts 108 and the lower housing parts 110 are also brazed to the base 165 of the seating slots in the regions located between the points where the fuel gas branch channels 158 or the exhaust gas branch channels open out into the seating slots 156 so that the entire intermediary space between the housing 106 and the boundary walls 162, 164, 165 of the seating slot 156 in these regions is filled up with the brazing material (see FIG. 5).

In order to ensure the requisite electrical insulation between the distributor elements 146 on the one hand and the housings 106 of the fuel cell units 102 on the other, the upper housing part 108 and the lower housing part 110 of each fuel cell unit 102 are provided with a ceramic coating 168 consisting of a ceramic material which exhibits an electrically insulating effect at the operating temperature of the fuell cell stack 100 at those places which come into contact with the braze layer 166.

The ceramic coating 168 of the upper housing part 108 can extend over the entire upper surface 170 of the upper housing part 108 or else just over those points at which the upper housing part 108 is brazed to a distributor element 146.

The ceramic coating 168 of the lower housing part 110 may extend over the entire area of the lower surface 172 of the lower housing part 110 surrounding the central contact field 134 or else just over those points at which the lower housing part 110 is brazed to one of the distributor elements 146.

The electrically insulating ceramic coatings 168 are applied by a thermal spraying process such as to produce a layer thickness of, for example, approximately 30 μm to approximately 500 μm for example.

Methods suitable for this purpose are atmospheric plasma spraying, vacuum plasma spraying or flame spraying for example.

The following insulating materials which are applicable by thermal spraying are suitable as a material for the ceramic coatings 168 for example:
99.5% aluminium oxide;
a mixture consisting of 97 percentage weight aluminium oxide and 3 percentage weight titanium dioxide;
yttrium-stabilized zirconium dioxide 5YSZ or 8YSZ;
a mixture consisting of 70 percentage weight aluminium oxide and 30 percentage weight magnesium oxide;
an aluminium magnesium spinel.

As an alternative to an upper housing part 108 or to a lower housing part 110 having a ceramic insulating layer applied by thermal spraying, use can also be made of housing parts consisting of a highly corrosion resistant steel containing aluminium which has been provided with a ceramic coating 168 of aluminium oxide at the points that are to be brazed by pre-oxidation of the aluminium-bearing metallic material.

In particular, such housing parts can be formed from the steel alloy that is known by the name “FeCrAlY” or else “Aluchrom Y”.

The composition of the FeCrAlY alloy is as follows: 30 percentage weight chromium, 5 percentage weight aluminium, 0.5 percentage weight yttrium, the remainder iron.

The housing parts that have been made by punching them out from a sheet of this steel alloy and then subjecting them to shaping processes are brought into an oxygen-containing atmosphere (into air for example) and kept at a temperature of approximately 1,100° C. for a period of two hours for example. As a result of this temperature treatment in an oxygen-containing atmosphere, the ceramic coating 168 consisting of aluminium oxide is produced on the upper surface of the housing parts.

The ceramic coatings 168 on the housing parts 108, 110 can be produced before or after the connection of the two housing parts 108, 110 to the housing 106 of a fuel cell unit 102.

For the purposes of brazing the upper housing part 108 and the lower housing part 110 to the distributor elements 146, the same brazing materials as were described hereinabove in connection with the brazing of the electro-chemical unit 112 and the upper housing part 108 can be used, and the brazing process can take place under the same conditions.

In particular, the brazing material needed for this process can be inserted in the form of a suitably cut brazing foil between the upper housing part 108 or the lower housing part 110 and the respective distributor element 146 or else it could be applied in the form of a bead of brazing material to the upper surface 170 of the upper housing part 108 or to the lower surface 172 of the lower housing part 110 and/or to the respective distributor element 146 by means of a dispenser.

Furthermore, it is also possible for the brazing material to be applied to the upper housing part 108 or to the lower housing part 110 and/or to the respective distributor element 146 by means of a pattern printing process, a silk-screen printing process for example.

A silver based braze with a copper additive can be used as the brazing material, for example, a silver based braze with the composition (in mol %): Ag-4Cu or Ag-8Cu.

The brazing process takes place in an air atmosphere. The brazing temperature amounts to 1,050° C. for example, the duration of the brazing process to approximately 5 minutes for example. Copper oxide forms in situ during the process of brazing in air.

As an alternative thereto, a silver based braze without a copper additive could also be used as the brazing material. Such a copper-free braze offers the advantage of a higher solidus temperature (this amounts to approximately 960° C. without a copper additive, to approximately 780° C. with a copper additive). Since pure silver does not wet ceramic surfaces, Copper(II)oxide is added to the silver based brazes without a copper additive for the purposes of reducing the edge angle. The brazing process using silver based brazes without a copper additive takes place in an air atmosphere or in an inert gas atmosphere, for example under argon.

Suitable silver based brazes without an additive of elemental copper have the composition (in mol percent): Ag-4CuO or Ag-8CuO for example.

An additive of titanium can serve to further improve the wetting process (reduction of the edge angle). An intimate mixture of the appropriate components in powder form is used for the production of the braze. The braze alloy is formed in situ from this mixture. The titanium is added to this mixture in the form of titanium hydride. A metallic titanium is formed from the hydride at approximately 400° C. Suitable silver based brazes without an additive of elemental copper, but with an additive of titanium have the composition (in mol percent): Ag-4CuO-0.5Ti or Ag-8CuO-0.5Ti for example.

In this case too, the brazing temperature also preferably amounts to approximately 1,050° C., and the duration of the brazing process to approximately 5 minutes for example.

Furthermore, active brazes can also be used as a brazing material for brazing the upper housing part 108 and the lower housing part 110 to the distributor elements 146.

Active brazes are metallic alloys which contain small quantities of boundary-surface-active elements (e.g. titanium, zirconium, hafnium, niobium and/or tantalum) and are thus able to lower the boundary surface energy between a ceramic material and the braze melt to such an extent that wetting of the ceramic material by the braze can take place.

The active brazing technique using active brazes enables ceramic ceramic/metal bonds to be produced in a single-step bonding process without the need for the ceramic bonding areas to be previously metallised. The wetting of the ceramic bonding areas by the braze is thereby ensured as a result of the use of an active braze.

A suitable active braze is sold under the name “Copper ABA” by the company Wesgo Metals, 610 Quarry Road, San Carlos, Calif. 94070, USA for example.

This active braze has the following composition: 2 percentage weight Al; 92.7 percentage weight Cu; 3 percentage weight Si; and 2.3 percentage weight Ti.

In particular, the brazing process can be carried out in accord with the following temperature program:
Insofar as the braze material is applied in the form of a braze paste, the braze paste will dry within a duration of approximately 10 minutes at a temperature of approximately 150° C.
Subsequently, brazing takes place in three steps, whereby in a first step, the components that are to be brazed together are heated up from the ambient temperature to a temperature of approximately 300° C. for a period of one hour, in a succeeding second step, the components that are to be brazed are heated up from a temperature of approximately 300° C. to a temperature of approximately 550° C. within a period of three hours and in a third step, the components that are to be brazed together are heated up from a temperature of approximately 550° C. to a final temperature of approximately 1,050° C. within a period of three hours, whereby the final temperature is maintained for a time span of approximately 5 minutes for example.
After the brazing process, the components that have been brazed together are cooled down to the ambient temperature over a longer time span, overnight for example.

In order to prevent the braze material from flowing beyond the region that is to be brazed in an unwanted manner, a braze stop material can be applied to those regions of the upper housing part 108 and the lower housing part 110 and the respective distributor element 146 which are to remain free from the braze material.

Suitable braze stop materials are sold under the names “Stopyt Liquid” or “Stopyt Liquid # 62A” by the company Wesgo Metals, 610 Quarry Road, San Carlos, Calif. 94070, USA.

If the brazing procedure is carried out in a vacuum or in an inert gas atmosphere, then care should be taken to see that the oxygen partial pressure does not drop below a certain lower limit as the cathode of the KEA unit 118 would otherwise be destroyed.

In the case of a cathode of lanthanum strontium manganate (LSM), the lower limit for the oxygen partial pressure amounts to approximately 1 ppm (10⁻⁴ bar); in the case of a cathode of lanthanum strontium cobalt ferrite (LSCF), the lower limit for the oxygen partial pressure amounts to approximately 10 ppm (10⁻³ bar).

The fuell cell stack 100 manufactured by brazing the fuel cell units 102 to the distributor elements 146 is arranged in an external housing 174 in order to cut off the oxidizing agent chambers 142 from the surrounding atmosphere.

The external housing 174 can, for example, be formed from a metallic material. In order to exclude the possibility of a short-circuit between the fuel cell units 102 succeeding one another in the direction of the pile 104 in this case, the upper housing parts 108 and the lower housing parts 110 of the fuel cell units 102 are also provided with the electrically insulating ceramic coating 168 along the edges thereof running transversely to the distributor elements 146 so that the housings 106 of the fuel cell units 102 only rest against the external housing 174 via these electrically insulating ceramic coatings 168 (see FIG. 6).

In operation of the fuell cell stack 100, a fuel gas is supplied via the fuel gas supply channels 148 of the first distributor element 146a to the respective fuel gas chambers 176 of the fuel cell units 102 that are formed between the lower housing part 110 and the electro-chemical units 112, and the exhaust gas produced by oxidation at the anodes of the KEA unit 118 as well as any unused fuel gas is removed from the fuel gas chambers 176 through the exhaust gas outlet openings, the exhaust gas branch channels and the exhaust gas removal gas removal channels 152 of the second distributor element 146b.

In like manner, an oxidizing agent, air for example, is supplied to the oxidizing agent chamber 142 of each fuel cell unit 102 through the oxidizing agent supply channels 150 and the oxidizing agent branch channels 160 of the first distributor element 146a, and any unused oxidizing agent is removed from the oxidizing agent chambers 142 through the oxidizing agent branch channels and the oxidizing agent removal channels 154 of the second distributor element 146b.

In the embodiment of a fuell cell stack 100 being described in exemplary manner here, the streams of fuel gas and oxidizing agent are directed through the fuel cell units 102 in the same direction; however, provision could also be made for the stream of oxidizing agent to flow in the opposite direction to the stream of fuel gas, in that, for example, the oxidizing agent supply channels 150 of the first distributor element 146a are interchanged with the oxidizing agent removal channels 154 of the second distributor element 146b.

In operation of the fuell cell stack 100, the KEA units 118 are, for example, at a temperature of 850° C. at which the electrolyte in each KEA unit 118 is conductive for oxygen ions. The oxidizing agent from the oxidizing agent chambers 142 picks up electrons at the cathodes and delivers doubly negatively charged oxygen ions to the electrolytes, said ions then migrating through the electrolytes to the anodes. At the anodes, the fuel gas from the fuel gas chambers 176 is oxidized by the oxygen ions from the electrolytes and thereby donates electrons to the anodes.

The electrons freed by the reaction at the anodes are supplied from the anodes via the substrates 114 and the contact materials 116 as well as the lower housing parts 110 to the respective cathodes of the neighbouring fuel cell units 102 which are located on the lower surface of the contact fields 134 of the lower housing parts 110 and thus make the cathode reaction possible.

The upper housing part 108 and the lower housing part 110 of each fuel cell unit 102 are connected to one another in an electrically conductive manner.

However, the housings 106 of the fuel cell units 102 succeeding one another in the direction of the pile 104 that are formed by a respective upper housing part 108 and a respective lower housing part 110 are electrically insulated from one another by the ceramic coatings 168 on the housings 106.

Simultaneously thereby, a gas-tight connection between these components is ensured due to the brazing of the housings 106 to the distributor elements 146 so that the oxidizing agent chambers 142 and the fuel gas chambers 176 of the fuel cell units 102 are separated from one another in gas-tight manner.

In particular, the distributor elements 146 can be formed from a metallic material.

The distributor elements 146 may be in the form of solid material blocks in which the gas distribution channels and the gas branch channels are formed by machining processes.

As an alternative thereto, it is also possible for the distributor elements 146 to be in the form of sheet-metal preforms, consisting of shaped sheet-metal shells for example, whereby the gas distribution channels and the gas branch channels of the distributor elements 146 are formed from a sheet metal material by suitable shaping and/or pressing processes.

In a (not illustrated) variant of the previously described embodiment of a fuell cell stack 100, provision is made for the electrically insulating ceramic coating not to be arranged on the housings 106, but instead, on the distributor elements 146.

In a further variant, provision is made for both the housings 106 and the distributor elements 146 to be provided with a respective electrically insulating ceramic coating.

In a further (not illustrated) variant of the previously described embodiment of a fuell cell stack 100, provision is made for the upper housing parts 108 and the lower housing parts 110 of the fuel cell units 102 not to be brazed to the distributor elements 146 by means of a metallic braze, but rather, by means of a glass solder which is electrically insulating at the operating temperature of the fuell cell stack 100.

Since, in this case, the electrically insulating effect between the housings 106 and the distributor elements 146 is already ensured by the glass solder, one can dispense with the electrically insulating ceramic coatings 168 on the upper housing parts 108 and the lower housing parts 110 in such an embodiment.

A suitable electrically insulating glass solder may be composed of the glass solder known from EP 0 907 215 A1 for example, i.e. it may contain 11 to 13 percentage weight aluminium oxide (Al₂O₃), 10 to 14 percentage weight boron oxide (BO₂), about 5 percentage weight calcium oxide (CaO), 23 to 26 percentage weight barium oxide (BaO) and about 50 percentage weight silicon oxide (SiO₂).

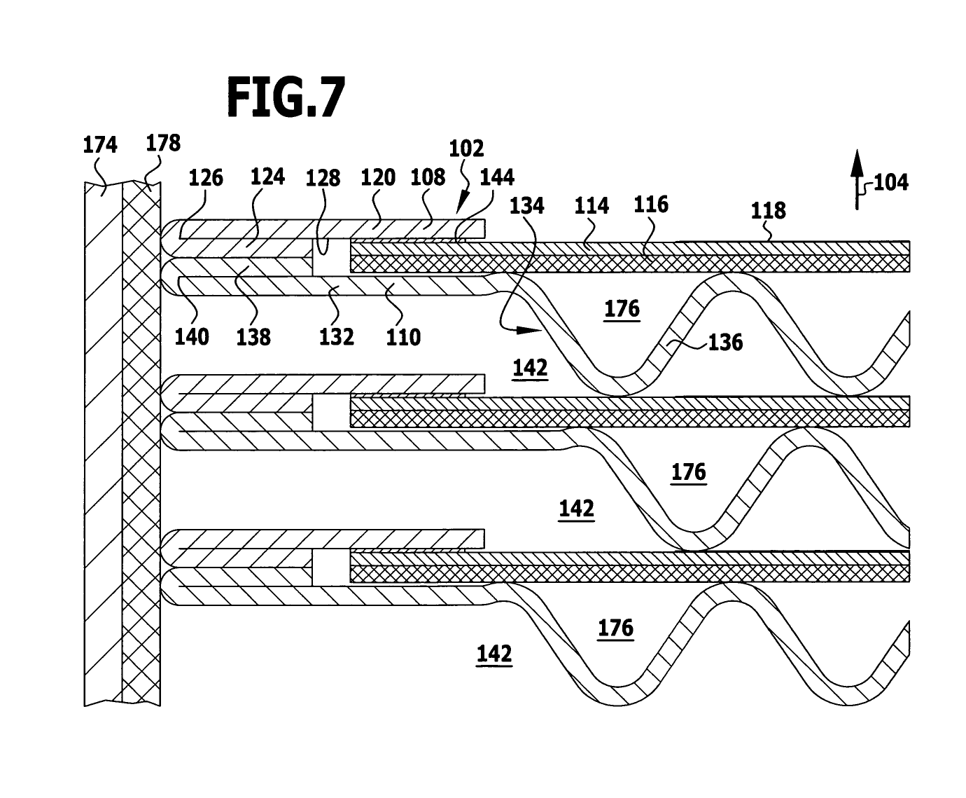

A further embodiment of a fuell cell stack 100 that is illustrated in FIG. 7 differs from the previously described embodiment of a fuell cell stack 100 only in that the housings 106 of the fuel cell units 102 are not provided with an electrically insulating ceramic coating 168 on the edges thereof running transversely to the distributor elements 146, but instead, the inner surface of the external housing 174 facing the housings 106 of the fuel cell units 102 is provided with an insulating layer 178 consisting of a material which is electrically insulating at the operating temperature of the fuell cell stack 100 in order to ensure the requisite electrical insulation between the housings 106 of the fuel cell units 102 on the one hand and the external housing 174 of the fuell cell stack 100 on the other as well as the mutual electrical insulation needed between the housings 106 themselves.

The electrically insulating insulation layer 178 can, in particular, be formed from a ceramic material, from Al₂O₃ for example.

In all other respects, the second embodiment of a fuell cell stack 100 that is illustrated in FIG. 7 coincides in regard to the structure and functioning thereof with the first embodiment illustrated in FIGS. 1 to 6, and to that extent reference should be made to the previous description.

1. A fuell cell stack comprising a plurality of fuel cell units succeeding one another in a direction of the pile, wherein each of the fuel cell units comprises a housing incorporating at least one housing part which consists of a metallic material,
wherein the fuell cell stack comprises at least one distributor element which comprises at least one gas distribution channel for supplying a fuel gas or an oxidizing agent to a plurality of fuel cell units or for removing exhaust gas or surplus oxidizing agent from a plurality of fuel cell units,
wherein at least one housing part of at least one fuel cell unit is brazed to the at least one distributor element.

2. A fuell cell stack in accordance with claim 1, wherein the at least one housing part and the distributor element are brazed to one another by means of a braze material which is electrically insulating at the operating temperature of the fuell cell stack.

3. A fuell cell stack in accordance with claim 1, wherein the at least one housing part is provided with a coating of a ceramic material and is brazed to the at least one distributor element at at least one position that is provided with the ceramic coating.

4. A fuell cell stack in accordance with claim 1, wherein the at least one distributor element is provided with a coating of a ceramic material and is brazed to the at least one housing part at at least one position that is provided with the ceramic coating.

5. A fuell cell stack in accordance with claim 3, wherein the at least one housing part and the at least one distributor element are brazed to one another by means of a metallic braze.

6. A fuell cell stack in accordance with claim 3, wherein the ceramic coating comprises aluminium oxide and/or titanium dioxide and/or zirconium dioxide and/or magnesium oxide.

7. A fuell cell stack in accordance with claim 3, wherein the ceramic coating is produced by a thermal spraying process, in particular by an atmospheric plasma spraying process, by a vacuum plasma spraying process or by a flame spraying process.

8. A fuell cell stack in accordance with claim 3, wherein the at least one housing part and/or the at least one distributor element is formed from a metallic alloy which contains an oxidisable constituent.

9. A fuell cell stack in accordance with claim 8, wherein the metallic alloy contains aluminium and/or zirconium as the oxidisable constituent.

10. A fuell cell stack in accordance with claim 8, wherein the ceramic coating is produced by oxidation of an oxidisable constituent of the metallic alloy.

11. A fuell cell stack in accordance with claim 3, wherein the thickness of the ceramic coating is approximately 20 μm to approximately 1,000 μm.

12. A fuell cell stack in accordance with claim 3, wherein the at least one housing part is brazed to the at least one distributor element by means of a silver based braze incorporating a copper additive.

13. A fuel cell stack in accordance with claim 3, wherein the at least one housing part is brazed to the at least one distributor element by means of a silver based braze without a copper additive.

14. A fuell cell stack in accordance with claim 13, wherein the silver based braze contains an additive of copper oxide.

15. A fuell cell stack in accordance with claim 3, wherein the at least one housing part is brazed to the at least one distributor element by means of a silver based braze incorporating a titanium additive.

16. A fuell cell stack in accordance with claim 3, wherein the at least one housing part is brazed to the at least one distributor element by means of an active braze.

17. A fuell cell stack in accordance with claim 1, wherein the housing of at least one fuel cell unit comprises at least two housing parts made of a metallic material which are both brazed to the at least one distributor element.

18. A fuell cell stack in accordance with claim 17, wherein the at least two housing parts of the housing of the at least one fuel cell unit are fixed together, preferably by welding and/or brazing.

19. A fuell cell stack in accordance with claim 1, wherein the at least one housing part comprises at least one passage opening, through which, in the assembled state of the fuell cell stack, a cathode electrolyte anode unit of the fuel cell unit is accessible for enabling electrical contact to be made by another fuel cell unit of the fuell cell stack.

20. A fuell cell stack in accordance with claim 1, wherein the at least one housing part comprises a contact field for making electrical contact with a cathode electrolyte anode unit of another fuel cell unit of the fuell cell stack.

21. A fuell cell stack in accordance with claim 1, wherein the at least one housing part is formed from a metal sheet.

22. A fuell cell stack in accordance with claim 1, wherein the at least one housing part is formed from a highly corrosion resistant steel.

23. A fuell cell stack in accordance with claim 1, wherein the at least one housing part does not comprise a passage opening for a fuel gas, an oxidizing agent or an exhaust gas.

24. A fuell cell stack in accordance with claim 1, wherein the housing of at least one fuel cell unit comprises at least one passage opening for a fuel gas, an oxidizing agent or an exhaust gas which is connected to a gas distribution channel in the at least one distributor element.

25. A fuell cell stack in accordance with claim 24, wherein the at least one distributor element comprises at least one gas branch channel which branches off from the at least one gas distribution channel and via which the at least one passage opening in the housing of the at least one fuel cell unit is connected to the at least one gas distribution channel.

26. A fuell cell stack in accordance with claim 24, wherein the at least one passage opening is bounded laterally by at least one region of the housing of the fuel cell unit which comprises a folded edge.

27. A fuell cell stack in accordance with claim 1, wherein the at least one distributor element comprises at least one seating for the at least one housing part which accommodates a boundary region of the housing part.

28. A fuell cell stack in accordance with claim 1, wherein the fuell cell stack comprises at least two distributor elements which each incorporate at least one gas distribution channel, and wherein the at least one housing part of at least one fuel cell unit is brazed on two mutually opposite sides thereof to a respective one of the distributor elements.
